(19) United States
(12) Patent Application Publication
(10) Pub. No.: US 2011/0101697 A1
(43) Pub. Date: May 5, 2011

(54) SYSTEMS AND METHODS FOR SUPPORTING UNDERWATER ENERGY CONVERSION DEVICES

(75) Inventors: Daniel E. Power, III, Pace, FL (US); Ned R. Hansen, Hyde Park, UT (US)

(73) Assignee: OCEANA ENERGY COMPANY, Washington, DC (US)

(21) Appl. No.: 13/002,124

(22) PCT Filed: Jun. 29, 2009
(86) PCT No.: PCT/US2009/049034

§ 371 Date: Dec. 30, 2010

Related U.S. Application Data
(60) Provisional application No. 61/077,473, filed on Jul. 1, 2008.

(51) Int. Cl. F03B 13/10

(52) U.S. Cl. 290/54

(57) ABSTRACT

A system for energy conversion may comprise at least one floating support structure configured to float on a body of water, at least one anchoring device configured to anchor the at least one floating support structure in a substantially stationary position on the body of water, and at least one energy conversion device mounted to the at least one floating support structure so as to be submergible in the water body in a substantially stationary position. In a submerged position, water currents in the water body may interact with the at least one energy conversion device to generate electricity.

### TECHNICAL FIELD

The present teachings relate generally to the generation of electricity and/or hydrogen from liquid currents, for example, tidal currents. In particular, the present teachings relate to systems and methods for supporting underwater energy conversion devices within a body of liquid.

### BACKGROUND

The section headings used herein are for organizational purposes only and are not to be construed as limiting the subject matter described in any way.

Tidal power, sometimes called tidal energy, is a form of hydropower that exploits the movement of water caused by tidal currents, or the rise and fall in sea levels due to the tides. As the waters rise and then fall, a flow, or current, is generated. Additional forms of differential pressure can also cause water to flow, and create water speeds sufficient to enable the conversion of the water's flow energy into other useful forms of energy.

Since tides are caused by the orbital mechanics of the solar system and are considered inexhaustible within a human timeframe, tidal power is classified as a renewable energy source. Unlike other renewable energy sources, such as wind and solar power, however, tidal power is reliably predictable. Water currents area source of renewable power that is clean, reliable, and predictable years in advance (for ease of integrating with an existing energy grid). Additionally, by virtue of the basic physical characteristics that accrue to seawater, namely, its density (832 times that of air) and its non-compressibility, this medium holds unique, “ultra-high-energy-density”potential, in comparison to other renewable energy sources, for generating renewable energy. This potential is amplified when the volume and flow rates present in many coastal locations worldwide are factored in.

Since hydrogen is formed from the electrolysis of water, it also exists in an unlimited supply. Electrolysis is the method of separating water into hydrogen and oxygen. Renewable energy, such as tidal power, can be used to power electrolyzers to produce hydrogen from water. After the hydrogen is produced in an electrolyzer, it can be used in a fuel cell to also produce electricity.

The power produced from the conversion of water currents can also be utilized at the point of conversion for any application that requires significant amounts of energy, such as, for example, the desalination of water or the processing of materials.

Tidal power, therefore, may offer an efficient, long-term source of pollution-free electricity, hydrogen production, and/or other useful forms of energy that can help reduce the world's current reliance upon petroleum, natural gas, and coal. Reduced consumption of fossil fuel resources can in turn help to decrease the output of greenhouse gases into the world's atmosphere. Unfortunately, although water currents have enormous potential for electricity and hydrogen generation, to date, they have not been widely deployed because the relatively low cost of fossil fuels has made investment in alternate energy sources not economically feasible. In addition, some conventional schemes for harnessing tidal power have relatively high civil infrastructure costs and suffer from various environmental problems. For example, some conventional systems for extracting tidal energy involve the building of a dam or a barrage across a bay or estuary with large differences in elevation between high and low tides. Water retained behind the dam at high tide generates a power head sufficient to generate electricity as the tide ebbs, and water released from within the dam turns conventional turbines. The building of a dam or barrage, however, may be time-intensive, costly, and often not feasible due to a shortage of viable sites that meet the elevation requirements associated with such a project.

More recently, tidal power schemes rely on the use of the kinetic energy of moving water to power turbine-like structures, as opposed to the potential energy from the difference in height (or head) between high and low tides. Such systems can act like underwater windmills, and have a much lower resulting cost and ecological impact compared to the older barrage systems.

Issues that can arise, however, in utilizing this type of power scheme include the need to provide an effective way to support and anchor the energy conversion device in a location that is best suited for tidal power generation. A seabed, for example, is often not readily accessible, making it difficult to directly support the generator by building a platform or the like attached to the sea floor. For optimal power generation, the support structure should also be designed to not interfere with the tidal currents, which can also make it difficult to use any type of support structure that protrudes too far below the surface of the water body. It additionally may be desirable to have the ability to easily access the underwater energy conversion device for servicing and/or maintenance, as well as the ability to easily move the underwater energy conversion device to a new location if desired.

### SUMMARY

The present teachings may solve one or more of the above-mentioned problems and/or may demonstrate one or more of the above-mentioned desirable features. Other features and/or advantages may become apparent from the description that follows.

In accordance with various exemplary embodiments, the present teachings provide a system for energy conversion comprising at least one floating support structure configured to float on a body of water, at least one anchoring device configured to anchor the at least one floating support structure in a substantially stationary position on the body of water, and at least one energy conversion device mounted to the at least one floating support structure so as to be submergible in the water body in a substantially stationary position. In a submerged position, water currents in the water body interact with the at least one energy conversion device to generate electricity.

In accordance with various exemplary embodiments, the present teachings further provide a method for energy conversion comprising positioning at least one floating support structure on a body of water, anchoring the at least one floating support structure in a substantially stationary position on the body of water, mounting at least one energy conversion device to the at least one floating support structure, and submerging the at least one energy conversion device in the body of water in a substantially stationary position so that water currents in the body of water interact with the at least one energy conversion device to generate electricity.

Additional objects and advantages will be set forth in part in the description which follows, and in part will be obvious from the description, or may be learned by practice of the present teachings. At least some objects and advantages of the present teachings may be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments and together with the description, serve to explain certain principles. In the drawings:

FIG. 1 is an overhead plan view of a double-hull floating support structure in accordance with an exemplary embodiment of the present teachings;

FIG. 2 is a cross-sectional view of the double-hull floating support structure of FIG. 1;

FIG. 3 is an overhead view of a double-hull floating support structure containing multiple hydroelectric generators in accordance with an exemplary embodiment of the present teachings;

FIG. 4 is a perspective view of an energy conversion device in accordance with an exemplary embodiment of the present teachings;

FIG. 5 is a side view of a single-hull floating support structure in accordance with an exemplary embodiment of the present teachings;

FIG. 6 is a cross-sectional view of a multi-hull floating support structure in accordance with an exemplary embodiment of the present teachings;

FIG. 7 is a cross-sectional view of an adjustable elevation, double-hull floating support structure in a heightened position in accordance with an exemplary embodiment of the present teachings;

FIG. 8 is an overhead view of a plurality of floating support structures in a parallel array in accordance with an exemplary embodiment of the present teachings; and

FIG. 9 is an overhead view of a plurality of floating support structures in a two-dimensional array in accordance with an exemplary embodiment of the present teachings.

Although the following detailed description makes reference to illustrative embodiments, many alternatives, modifications, and variations thereof will be apparent to those skilled in the art. Accordingly, it is intended that the claimed subject matter be viewed broadly.

### DESCRIPTION OF EXEMPLARY EMBODIMENTS

Reference will now be made in detail to various embodiments, examples of which are illustrated in the accompanying drawings. However, these various exemplary embodiments are not intended to limit the disclosure. To the contrary, the disclosure is intended to cover alternatives, modifications, and equivalents.

The present teachings contemplate systems and methods for supporting within a body of liquid a device for the conversion of water current energy into other useful forms of energy. In particular, the present teachings contemplate systems and methods for supporting such energy conversion devices within a body of liquid which has currents to harness tidal currents or unidirectional currents such as, for example, the Gulf Stream.

By way of non-limiting example, systems and methods in accordance with various exemplary embodiments of the present teachings may be used to support an energy conversion device of the type having a closed-loop track and one or more blades that interact with fluid currents to move along the track and rotate about an axis of rotation. More specifically, the blades may interact with liquid currents moving in a direction substantially parallel to the axis of rotation, or, in other words, substantially perpendicular to a plane of rotation of the blades. Examples of various configurations of energy conversion systems that may be supported by the exemplary embodiments described herein are disclosed in U.S. Patent Application Publication No. 2007/0278796 A1, published Dec. 6, 2007, which is incorporated herein in its entirety.

In various exemplary embodiments, underwater energy conversion devices may be suspended from one or more stationary, floating support structures, permitting the energy conversion devices to be positioned within (e.g., underneath the surface of) a body of liquid to generate electricity and/or hydrogen from currents flowing within the liquid body. By way of example, the support structures may have a configuration and be positioned when supporting one or more energy conversion devices such that currents flowing within the liquid body move along a path in a direction substantially parallel to a lengthwise direction of the support structures. In various exemplary embodiments, the support structures may be hulls of a floating vessel.

Floating support structures in accordance with various exemplary embodiments of the present teachings may enable an operator to submerge an energy conversion device and substantially maintain the position of the device in a location where water currents are optimal for power generation. Further, floating support structures in accordance with various exemplary embodiments may facilitate moving the location of the energy conversion device within the body of water to a new location, accessing the energy conversion device for service and/or maintenance, and/or may minimize the ecological impact to a site where the energy conversion device is placed.

Mounting an energy conversion device such as, for example, the system disclosed in Publication No. US 2007/0278796 A1, incorporated by reference herein, to one or more floating support structures can enable an operator to submerge and maintain the position of the generator in a location where water currents are optimal for power generation, be it in an ocean, lake, river, or other body of liquid. Further, in accordance with various exemplary embodiments, the floating support structures may be configured to enable access to water currents in both shallow and deep water.

In various exemplary embodiments, floating support structures in accordance with the present teachings may be configured as floating vessels to permit moving the energy conversion device within a liquid body if desired. A floating vessel also may provide an area in which personnel may board the vessel to permit maintenance and/or servicing of one or more energy conversion devices supported by the floating vessel.

Furthermore, because in various exemplary embodiments, floating support structures in accordance with the present teachings have limited or no contact with the sea floor or river bed, the ecological impact of introducing an energy conversion device into an underwater environment may be minimized. Additionally, the floating support structures in accordance with various exemplary embodiments may facilitate maintaining a submerged position of an energy conversion device in a liquid body as compared to, for example, anchoring the generator to the floor (bed) of the body of liquid or to a structure mounted thereto. For example, in circumstances where the liquid body floor is relatively deep, accessing the floor to anchor the energy conversion device directly to the floor may not be feasible, or at the least may be impractical. Even if the floor is accessible, it may require scuba-diving or some other underwater vessel to reach the anchoring mechanism to access it, for example, to release the generator if it is desired to move it and/or service it. This may make servicing of the generator and/or moving it relatively costly and/or relatively difficult.

In order to generate electricity, hydrogen and/or other forms of energy from liquid currents, various exemplary embodiments of the present teachings contemplate supporting a submerged energy conversion device via a floating support structure that is anchored in a location where liquid currents flow so as to interact with the energy conversion device. By way of example, one or more energy conversion devices can be mounted and submerged in a body of liquid such that the liquid currents flowing therein are in a direction substantially parallel to an axis of rotation of the one or more energy conversion devices. Those ordinarily skilled in the art would recognize that other energy conversion devices having an axis of rotation that is substantially perpendicular or at another angle relative to the current may also be mounted utilizing the various exemplary embodiments of the present teachings.

Floating support structures suitable for use in accordance with various exemplary embodiments may include any available floating structures or devices, such as, for example, boats, barges, pontoons, platforms, floating docks, and/or buoys. In various exemplary embodiments, the floating support structures may be floating vessels capable of traveling on the body of liquid on their own accord. Those having skill in the art would understand that floating support structures not able to travel along a body of liquid on their own accord may nonetheless be moved along a body of liquid by other mechanisms, such as, for example, being towed by another vessel.

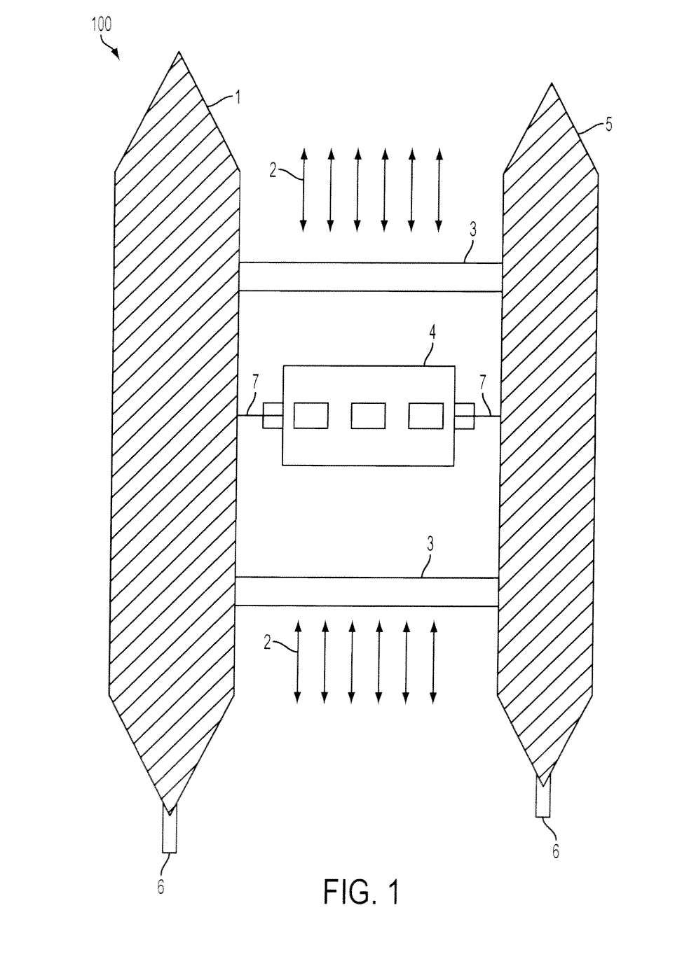

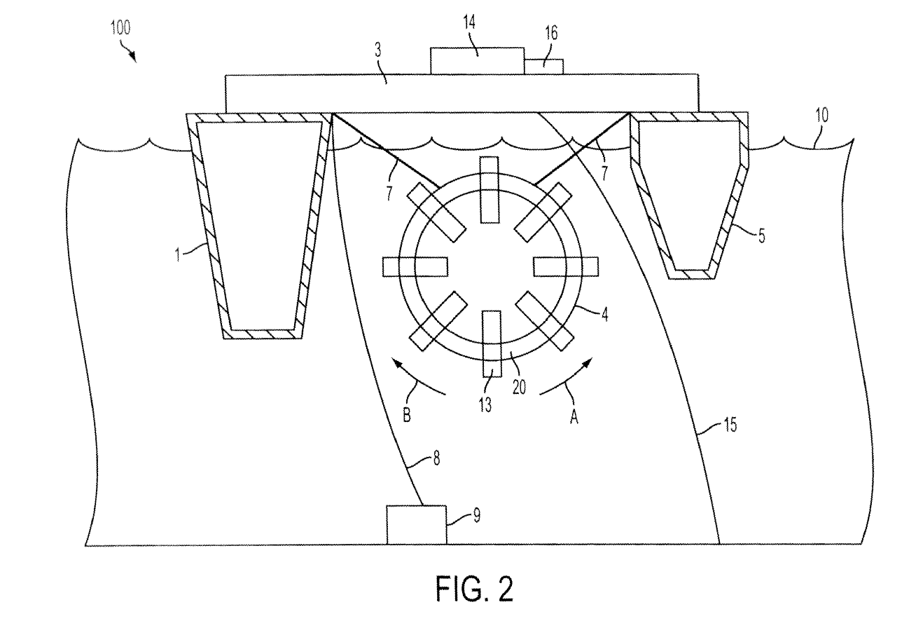

FIGS. 1 and 2 show multiple views of a floating support structure 100 comprising a double-hull floating support structure, having a configuration similar to, for example, the double hulls of a catamaran, in accordance with various exemplary embodiments of the present teachings. A first floating element 1 and a second floating element 5, which may be, for example, pontoon hulls, are connected by one or more connectors 3 and are configured to allow the floating support structure 100 to float in a body of water 10. In various exemplary embodiments, the distance between the first floating element 1 and second floating element 5 may be a distance sufficient to minimize interference of the floating elements 1 and 5 with the water flow through the energy conversion device. One or more tail fins 6 may help maintain the floating support structure's 100 stability and direction in relation to a water current direction 2. Further, to compensate for torque, the first floating element 1 and the second floating element 5 may have differing sizes. For example, in the exemplary embodiment of FIGS. 1 and 2, the first floating element 1 is larger than the second floating element 5.

In various exemplary embodiments of the present teachings, floating elements 1 and 5 may have a configuration (e.g., size and shape) to have relatively large drafts, for example, by reaching relatively deep into the body of water 10. This may help to provide good stability, for example, in strong winds and/or currents, or during maintenance of the energy conversion device(s).

In accordance with various exemplary embodiments, the floating elements 1 and 5 are positioned substantially parallel to the water current direction 2, and the floating support structure's 100 position is maintained by one or more anchors 9, connected to the floating support structure 100 via an anchor line 8. The anchor 9 maintains the floating support structure 100 in a substantially stationary position, meaning the floating support structure 100 can move, but not past the length of the anchor line 8. Various exemplary embodiments of the present teachings further contemplate maintaining the floating support structure's substantially stationary position with any anchoring device and by any technique possible, including the use of, lines, multiple anchors, weights, buoys, or a combination thereof. In various exemplary embodiments, anchors may be shared between a plurality of floating elements and/or between multiple floating support structures, exemplary embodiments of which are described in more detail below.

An energy conversion device 4 may be mounted to the floating support structure 100 via one or more fasteners 7. Although, two fasteners 7 are depicted in FIG. 2, it should be understood that any number of fasteners 7, including, for example, a single fastener, may be used to achieve desired mounting of the energy conversion device 4. In various exemplary embodiments, the fasteners 7 may be substantially rigid and/or include a linkage type structure. The length of the fasteners 7 may be selected so as to submerge the energy conversion device 4 and hold it at a position that minimizes interference of the floating support structure (e.g., floating elements 1 and 5) with the operation of the energy conversion device 4. By way of example, the fasteners 7 may have a length sufficient to hold the energy conversion device 4 at a depth below the floating elements 1, 5 (not shown) such that the interference of the floating elements 1 and 5 on the water current's interaction with the energy conversion device 4 is minimized. It will be understood, however, that the energy conversion device may or may not be positioned below one or more of the floating elements 1 and 5. Those ordinarily skilled in the art would understand how to select an arrangement and length of the fasteners 7 so as to minimize interference of the floating structure on the operation of the energy conversion device 4 while maximizing the interaction of the energy conversion device 4 with relatively strong currents, which are typically closer to the surface of the body of liquid. Factors that may influence the selection of the length and arrangement of the fasteners 7 include, but are not limited to, for example, the speed of the current, the size of the energy conversion device, the depth of the floating structures, etc.

The energy conversion device 4 may be mounted to the floating support structure 100 submerged in the body of water 10 such that its plane of rotation of is substantially perpendicular relative to the water current direction 2, so that the energy conversion device 4 can rotate about its axis as indicated by the arrows A and/or B. In various exemplary embodiments of the present teachings, the water current 2 may move substantially in a single direction. It should also be noted that in various exemplary embodiments, it is contemplated that the water current may be in the form of tidal currents, in which case the current may move in an ebb/tide or back-and-forth direction as indicated by the double arrow of the water current 2 in various figures. In such cases, in accordance with various exemplary embodiments, the rotation of the energy conversion device 4 may occur in the directions A and B depicted in FIG. 2.

In various exemplary embodiments of the present teachings, the energy conversion device 4 may be mounted directly to the at least one of the one or more connectors 3 (not shown).

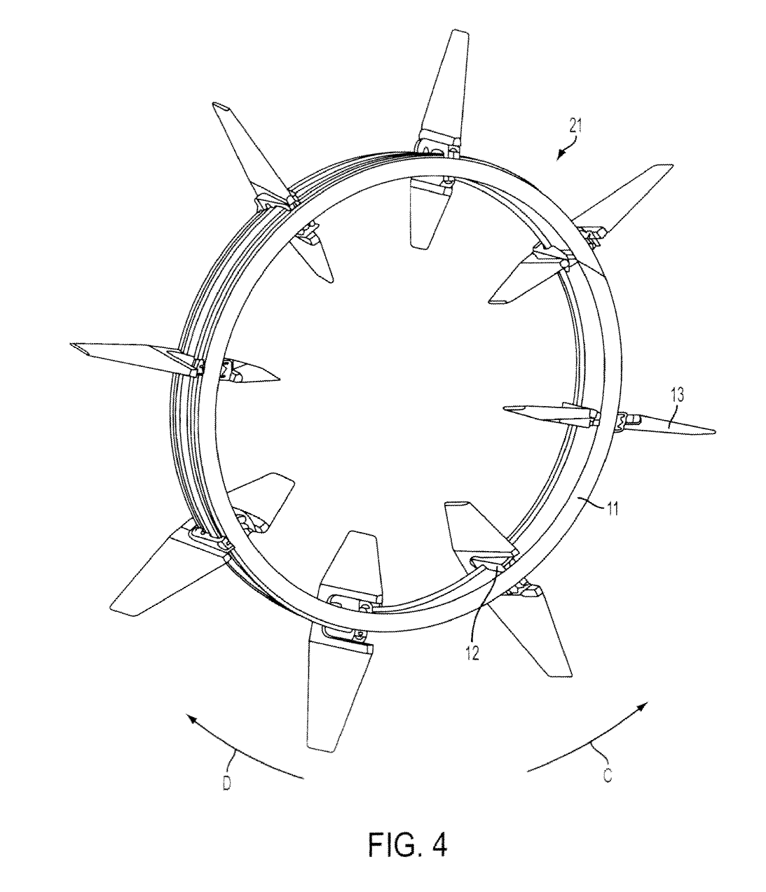

As discussed above, in accordance with various exemplary embodiments the energy conversion device 4 can be configured so as to interact with the water current in which the energy conversion device 4 is submerged such that the water current moves in a direction substantially parallel to the axis of rotation (e.g., substantially perpendicular to a plane of rotation) of blades 13 and/or a ring 20 as they rotate in either direction A or B shown in FIG. 2. By way of non-limiting example only, a system for generating electricity as disclosed in U.S. Application Publication No. 2007/0278796 A1, incorporated by reference herein, describes further details of some exemplary embodiments of energy conversion device configurations that could be supported by the floating support structures described herein. One such configuration is illustrated in FIG. 4

The system in FIG. 4 incorporates one or more trolleys 12 that move along a closed-loop track 11 as a result of the interaction of water currents with one or more blades 13 attached to each trolley 12. When an energy conversion device 21 is submerged in a liquid body such that a plane of rotation of the one or more blades 13 along the track 11 is substantially perpendicular to the water current direction, the flow of water through the energy conversion device 21 causes the trolleys 12 to move along the closed-loop track 11. Depending on the water current direction flowing through the energy conversion device of FIG. 4, the rotation may occur in either direction shown by arrows C and D in FIG. 4. The rotation of the blades 13 may generate electricity via a number of different mechanisms that are set forth in detail with reference to U.S. Application Publication No. 2007/0278796 A1. Also, in lieu of or in addition to trolleys 12 being moved along the track 11, the blades 11 may be attached to a ring that may be substantially concentrically disposed around the closed-loop track 11 and configured to rotate around the closed-loop track as the blades 13 rotate, as described in U.S. Application Publication No. 2007/0278796 A1, incorporated by reference herein.

U.S. Application Publication No. 2007/0278796 A1, incorporated by reference herein, discloses various techniques for converting the rotation of the energy conversion device 21 to electricity, including, for example, using magnets/coils interaction, hydraulic pumping mechanisms, and rotation of generator shafts. It is contemplated by the present teachings that any of the techniques disclosed in U.S. Application Publication No. 2007/0278796 A1 may be used in combination with the energy conversion devices herein to convert the rotation of those devices by the water currents interaction therewith to electricity, hydrogen generation, and/or other forms of energy, as is further described herein.

The present teachings further contemplate supporting other hydroelectric turbine and/or generator structures using floating support structures in accordance with the present teachings, and the energy conversion device shown in FIG. 4 and described in U.S. Application Publication No. 2007/0278796 A1 is exemplary and nonlimiting.

Various exemplary embodiments of the present teachings contemplate transmitting the electricity generated directly to a power grid via an electric grid cable 15 (depicted in FIG. 2), while others contemplate storing the electricity, for example, in a battery. The electricity generated can also be converted to DC (direct current), and the DC electrical power can be used to produce hydrogen from water by electrolysis in an electrolysis-type hydrogen generator 16, as depicted schematically in FIG. 2. Those having ordinary skill in the art would be familiar with techniques for the production of hydrogen via electrolysis and how to accomplish such production. Once hydrogen is produced, those having ordinary skill in the art would further understand how to store the hydrogen, such as, for example, in a tank, container, or fuel cell. The present teachings further contemplate other known uses for the electricity generated, such as, for example, the desalination of water.

Various exemplary embodiments of the present invention also consider pumping water from the body of water 10 into the hydrogen generator 16 for electrolysis (See FIG. 2). In order to run an electric water pump, various exemplary embodiments of the present teachings contemplate utilizing some relatively small portion of the electrical power produced by the energy conversion device 4 and/or mounting a conventional pump to the energy conversion device 4 to directly supply the mechanical power required to drive the water pump. In order to optimize the purity of the water supplied to the hydrogen generator 16, the water may be filtered by reverse osmosis filters before the water is used to produce hydrogen. The system may also include fuel cells that can use a portion of the produced hydrogen as a power source, which may be employed to aid in changing the location of the floating support structure.

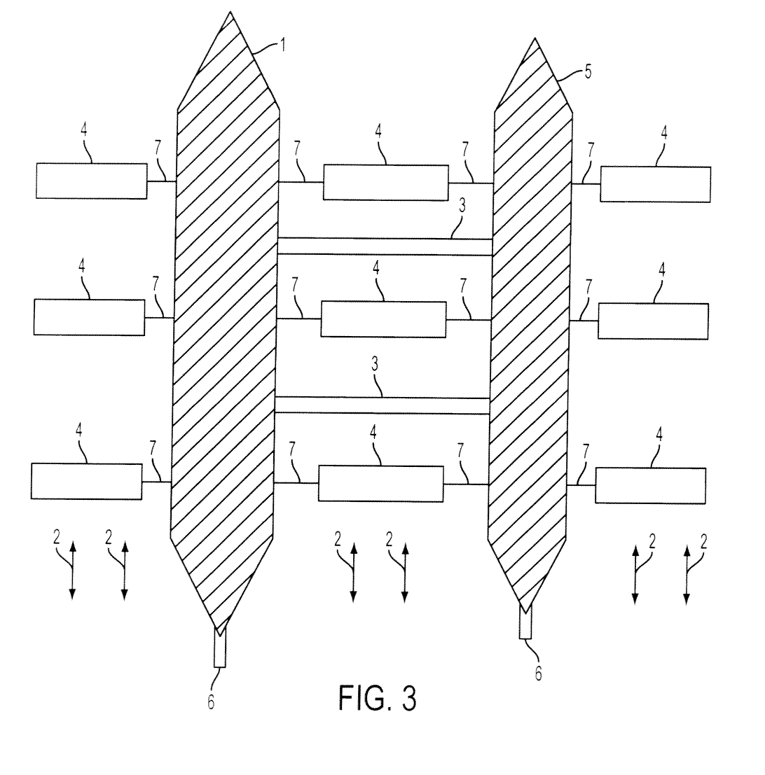

FIG. 3 is an overhead view of the floating support structure 100 of FIG. 1 for use in supporting multiple energy conversion devices 4 (depicted schematically in FIG. 3) in accordance with exemplary embodiments of the present teachings. The energy conversion devices 4 can be mounted in multiple positions along the floating elements 1 and 5. For example, the energy conversion devices 4 can be mounted between floating elements 1 and 5, and/or alongside either the first floating element 1 or the second floating element 5. It will be understood by skilled artisans of course that the number, positioning, and/or configuration (e.g., size) of the energy conversion devices 4 depicted in FIG. 3 is exemplary only and non-limiting of the present teachings, and a variety of positions and/or number of energy conversion devices 4 are envisioned with departing from the scope of the present teachings.

Because a double-hull floating support structure, such as a catamaran, is notably stable in strong currents, certain embodiments of the present teachings contemplate using double-hull floating support structures. Various exemplary embodiments of the present teachings also include a system and method embracing other floating support structure designs, such as multi-hull floating support structures, single-hull, and/or specialty-hull floating support structures, as needed to provide the functionality desired in the systems and methods of the present teachings.

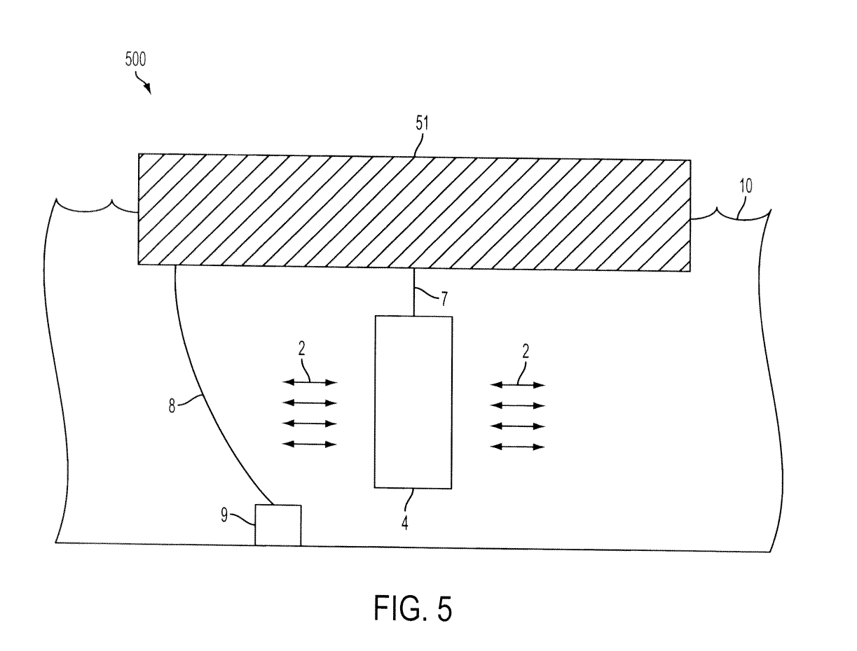

FIG. 5 is a side view of a single-hull floating support structure 500 in accordance with various exemplary embodiments of the present teachings. A floating element 51 is positioned such that its length is substantially parallel to the water current direction 2, and an energy conversion device 4 (depicted schematically for simplification) is mounted to the floating support structure via a fastener 7. In accordance with various exemplary embodiments, the floating element 51 is positioned substantially parallel to the water current direction 2, and the floating support structure's position is maintained by the anchor 9, connected to the floating support structure 500 via the anchor line 8. Those having skill in the art would understand that the shape of the floating element 51 is schematic and the floating element 51 may have a variety of configurations, including a configuration similar to the floating elements depicted in FIGS. 1, 3 and 6.

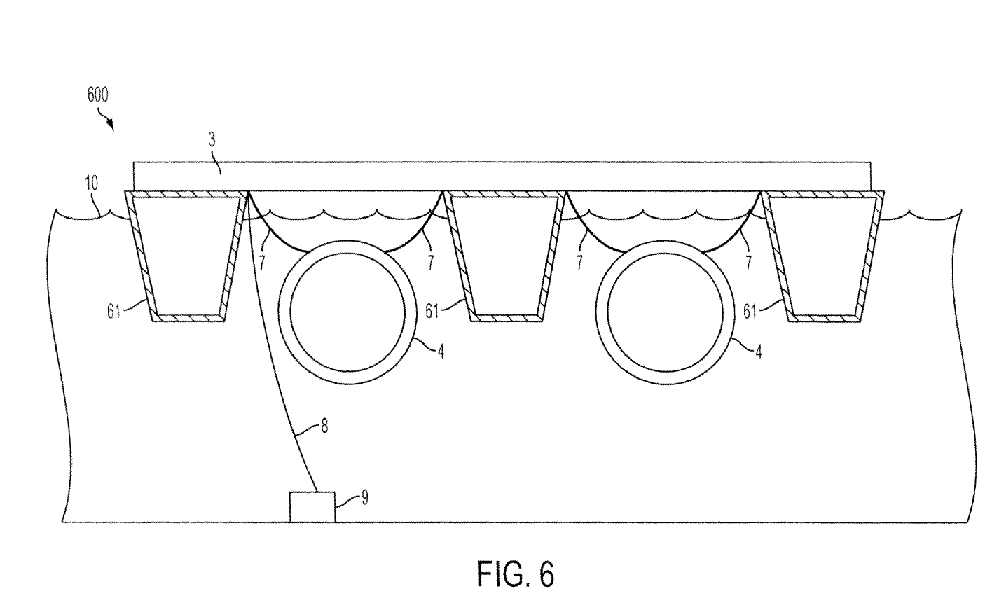

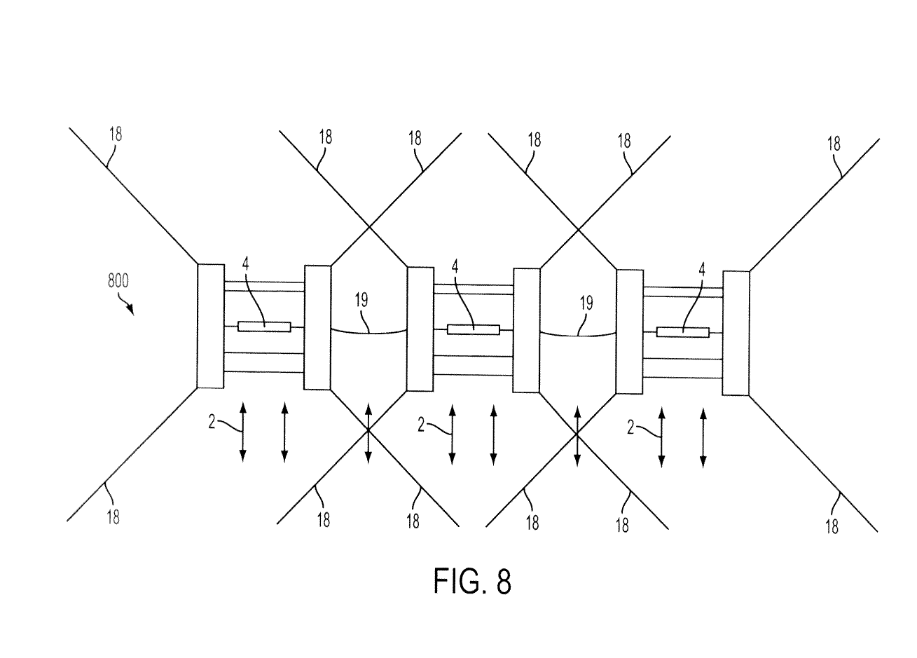

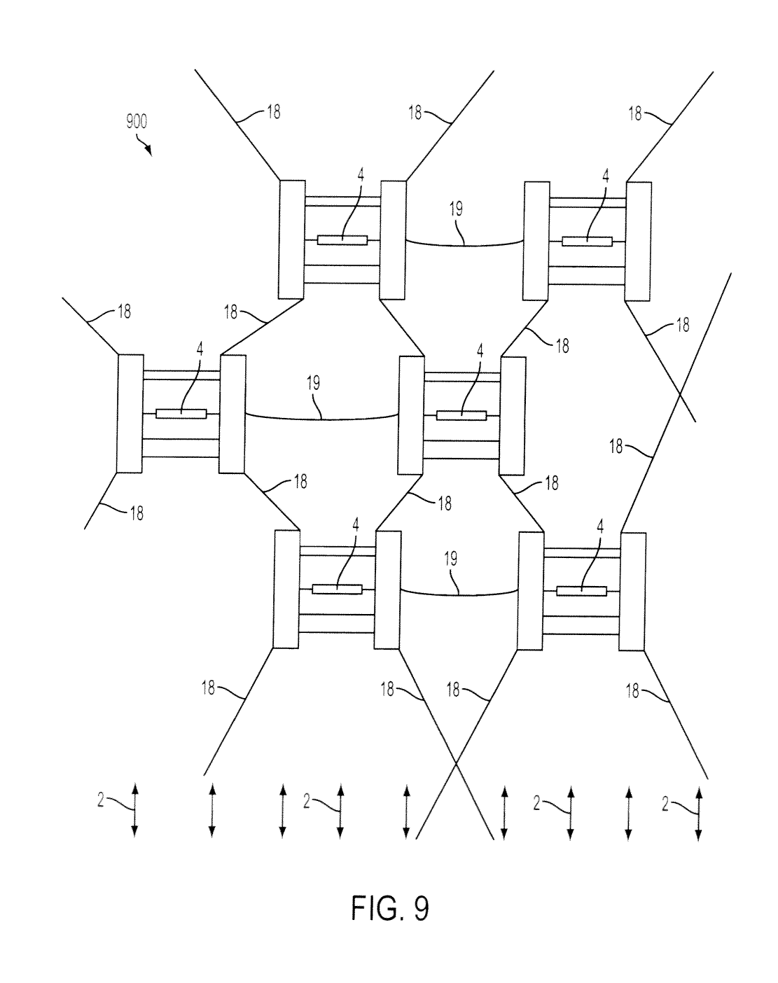

FIG. 6 shows a multi-hull floating support structure 600 in accordance with various exemplary embodiments of the present teachings. Multiple floating elements 61 are connected to each other by connectors 3, which may have a configuration similar to connectors 3 of FIGS. 1 and 2. One or more energy conversion devices 4 may be mounted to the floating support structure 600 between adjacent floating elements 61 via fasteners 7. In various exemplary embodiments of the present teachings, the floating elements 61 may be the same size and shape, as depicted in FIG. 6. It should also be noted that in various other exemplary embodiments that the floating elements 61 may be different sizes and/or shapes. For example, the floating support structure 600 may contain three floating elements 61, with the middle element 61 being larger in size then either side element 61. Of course, the number of floating elements may be chosen as desired and may include three or more. In various exemplary embodiments, for example, as described further below with reference to FIGS. 8 and 9, it is contemplated that a plurality of independent floating support structures are secured to each other in order to achieve a multi-hull support structure. Those having ordinary skill in the art would understand that the number and configuration of such independent floating support structures may be chosen as desired based on efficiency, cost-effectiveness, the number and configuration of the energy conversion devices desired to be supported, and other factors.

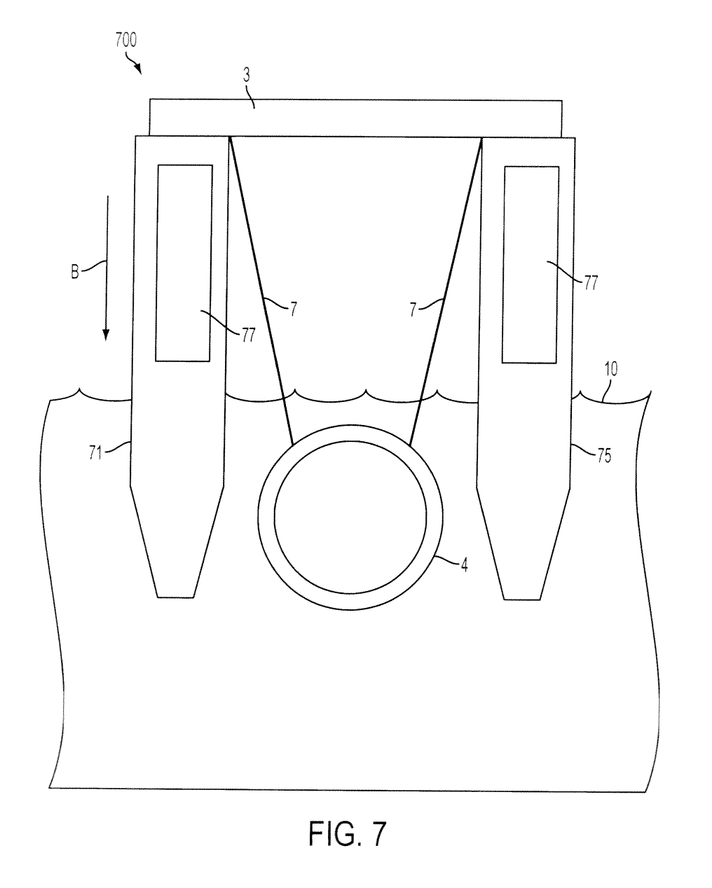

FIG. 7 shows an adjustable elevation, double-hull floating support structure 700 in accordance with yet another exemplary embodiment of the present teachings. This adjustable elevation feature may aide in raising the energy conversion device 4 out of the body of water 10 for maintenance, and likewise lowering it back into the body of water 10. Furthermore, this type of hull may be continuously adjusted in an attempt to maximize stability with regard to current weather and sea conditions, such as, for example, maximizing stability during storms and/or rough water conditions. In FIG. 7, a first floating element 71 and a second floating element 75 are shown in an extended position. Ballast chambers 77, in floating elements 71 and 75, can be filled with water from the body of water 10 upon which the floating support structure 700 floats. As the ballast chambers 77 fill with water, the elements 71 and 75 will move downward, increasing their draft, as shown by arrow B in FIG. 7. The floating elements 71 and 75 may have the same or differing sizes, as described with reference to the exemplary embodiment of FIGS. 1 and 2, for example. Those skilled in the art would recognize that adjustable elevation hulls may be used in lieu of or in addition to the hulls shown and described with reference to various other exemplary embodiments of the present teachings.

In order to maximize power generation at one location, various exemplary embodiments of the present teachings may use multiple stationary, floating support structures positioned in an array. In accordance with various exemplary embodiments, FIG. 8 illustrates a parallel array of floating support structures 800, and FIG. 9 illustrates a two-dimensional) array of multiple floating support structures 900. Those having ordinary skill in the art would understand that FIGS. 8 and 9 represent exemplary, non-limiting array configurations and other configurations may be envisioned and are considered within the scope of the present teachings. The floating support structures may be connected and stabilized into respective formation by lines 18. The array may be positioned in the water such that lengths of the floating elements associated with the floating support structures 800, 900 are substantially parallel to a water current direction 2. One or more energy conversion devices 4 may be mounted to each floating support structure of the array. Within the array, the floating support structures 800, 900 may be positioned just far enough apart so as to minimize interaction between the hydroelectric generators 4 and the next adjacent floating support structure. Electric lines 19 can run between adjacent floating support structures 800, 900 for energy collection and consolidation purposes, and the total electricity generated from the array can be transmitted to a power grid via an electric grid cable. Various exemplary embodiments of the present teachings contemplate each floating support structure 800, 900 and its associated energy conversion device(s) separately transmitting electricity to the power grid via a separate electric grid cable. Other exemplary embodiments contemplate wiring the floating support structures 800, 900 together and collecting the total electricity generated in one location, for transmission to the power grid via one central grid cable. Those having ordinary skill in the art would understand how to select the number and arrangement of the floating support structures as desired and based on various factors, such as, for example, cost-effectiveness, efficiency, the size of the site at which the energy conversion devices are to be deployed, the speed of the current, etc.

Various exemplary embodiments of the present teachings also may accommodate additional on-board functions of a stationary, floating support structure. For example, the floating support structure can be configured so as to permit the one or more energy conversion devices mounted thereto to be raised out of the water for maintenance and/or servicing. Various mechanisms can be used to raise the energy conversion devices out of the water, such as, for example a hinge/vertical slide or a linkage mechanism as disclosed in U.S. Application Publication No. 2007/0278796 A1, incorporated by reference herein. The floating support structures in accordance with various exemplary embodiments can additionally support shelter or man-quarters, which can be used by a technician, or the like, while visiting and/or working on the floating support structures.

Various exemplary embodiments of the present teachings may further support and utilize a propulsion device, such as, for example, an engine, outboard motor and/or sail, to move the floating support structure from one location to another. Various other exemplary embodiments also contemplate the use of a towing vessel to move the floating support structure from one location to another.

Various exemplary embodiments of the present teachings also contemplate the use of one or more stabilizing structures, such as, for example one or more hydrofoils (not shown) attached to one or more floating elements or a floating support structure. Use of one or more hydrofoils may increase lift with little drag by lifting the floating support structure onto a plane at a lower speed, thus resulting in less pitching and increased stability. This may be particularly desirable when moving the energy conversion device to a different location. Those having ordinary skill in the art are familiar with hydrofoil configurations that may be used in combination with the floating support structures of the present teachings.

The present teachings in various exemplary embodiments further contemplate regulating a mass distribution of a floating support structure to provide better stability in both normal operating conditions and during maintenance. Various exemplary embodiments consider utilizing ballast chambers to adjust the mass distribution of the floating support structure both vertically and longitudinally. For example, in FIG. 7, the ballast chambers 77 may be filled with water from the body of water 10 upon which the floating support structure 700 floats. As the ballast chambers 77 fill with water, the elements 71 and 75 will move downward, increasing their draft, thereby adjusting the mass distribution. Various other exemplary embodiments contemplate the use of additional types of ballast, including, for example, lead, or concrete, and/or the adjustment of fastener lengths to adjust the mass distribution.

While the present teachings have been disclosed in terms of exemplary embodiments in order to facilitate better understanding of the invention, it should be appreciated that the invention can be embodied in various ways without departing from the scope of the present teachings. Accordingly, while the present teachings have been disclosed mostly in terms of tidal and ocean currents, the teachings as disclosed work equally well for lake currents (e.g. in the Great Lakes), river currents, currents created by dams, and virtually any other type of current. Therefore, the invention should be understood to include all possible embodiments which can be embodied without departing from the scope set out in the appended claims.

Those ordinarily skilled in the art will appreciate that at least some of the features disclosed with respect to one or more exemplary embodiments may also be used in combination with other exemplary embodiments even if not explicitly described. Those with ordinary skill in the art would understand from the present teachings how to modify an exemplary embodiment to incorporate a feature that may be set forth in another exemplary embodiment without departing from the scope of the present teachings.

Those having ordinary skill in the art would further understand that energy conversion devices having configurations and operational principles other than those shown in the exemplary embodiments of the figures may also be supported by floating structures in accordance with the present teachings. For example, the floating support structures may also be used to support submerged hydroelectric generators that are configured to rotate about an axis that is substantially perpendicular to the water current.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the written description and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” include plural referents unless expressly and unequivocally limited to one referent. Thus, for example, reference to “a vessel” includes two or more different vessels. As used herein, the term “include” and its grammatical variants are intended to be non-limiting, such that recitation of items in a list is not to the exclusion of other like items that can be substituted or added to the listed items.

It will be apparent to those skilled in the art that various modifications and variations can be made to the systems and methods of the present disclosure without departing from the scope its teachings. Other embodiments will be apparent to those skilled in the art from consideration of the specification and practice of the teachings disclosed herein. It is intended that the specification and embodiment described herein be considered as exemplary only.

What is claimed is:

1. A system for energy conversion, comprising:
at least one floating support structure configured to float on a body of water;
at least one anchoring device configured to anchor the at least one floating support structure in a substantially stationary position on the body of water; and
at least one energy conversion device mounted to the at least one floating support structure so as to be submergible in the water body in a substantially stationary position,
wherein, in a submerged position, water currents in the water body interact with the at least one energy conversion device to generate electricity.

2. The system of claim 1, further comprising a hydrogen production system configured to produce hydrogen using the electricity generated by the at least one energy conversion device.

3. The system of claim 1, wherein the at least one floating support structure comprises a vessel.

4. The system of claim 3, wherein the vessel is a catamaran.

5. The system of claim 1, wherein the at least one floating support structure comprises a plural array of floating support structures.

6. The system of claim 5, wherein the plural array of floating support structures is a parallel array.

7. The system of claim 5, wherein the plural array of floating support structures is a two-dimensional array.

8. The system of claim 1, wherein the at least one floating support structure comprises at least one floating element.

9. The system of claim 8, wherein the at least one floating element comprises a hull.

10. The system of claim 8, wherein the at least on floating element comprises a plurality of hulls.

11. The system of claim 10, wherein at least some of the plurality of hulls have differing sizes.

12. The system of claim 9, wherein the at least one hull has an adjustable elevation.

13. The system of claim 1, wherein the at least one energy conversion device comprises at least one closed-loop track and at least one blade configured to move along the closed-loop track via interaction with water currents in the body of water.

14. The system of claim 1, further comprising an electricity collection system configured to transmit the electricity generated to an on-shore power grid.

15. The system of claim 1, further comprising an electricity collection system configured to store the electricity generated in an on-board battery.

16. A method for energy conversion, the method comprising:
positioning at least one floating support structure on a body of water;
anchoring the at least one floating support structure in a substantially stationary position on the body of water;
mounting at least one energy conversion device to the at least one floating support structure; and
submerging the at least one energy conversion device in the body of water in a substantially stationary position so that water currents in the body of water interact with the at least one energy conversion device to generate electricity.

17. The method of claim 16, further comprising transmitting the electricity generated to an on-shore power grid or an on-board battery.

18. The method of claim 16, further comprising converting the electricity generated to produce hydrogen from water by electrolysis.

19. The method of claim 18, further comprising pumping water from the water body into a hydrogen generator for electrolysis.
